(19) United States
(12) Patent Application Publication
(10) Pub. No.: US 2008/0271470 A1
(43) Pub. Date: Nov. 6, 2008

(54) Memory Wire Rotary Actuator

(75) Inventors: Jason Cheetham, Tauranga (NZ); Andrew J. Palmer, Tauranga (NZ)

Correspondence Address: REINHART BOERNER VAN DEUREN P.C., 2215 PERRYGREEN WAY, ROCKFORD, IL, 61107, US

(73) Assignee: ROBERTSHAW CONTROLS COMPANY, Richmond, VA (US)

(21) Appl. No.: 11/742,649

(22) Filed: May 1, 2007

(51) Int. Cl. F25D 21/08; G04F 5/10; H01H 61/00

(52) U.S. Cl. 62/156; 337/127; 368/156; 62/155

(57) ABSTRACT

A timer is provided. The timer includes a rotatable electrically non-conducting ratchet gear, an electrically conducting pawl mechanism, and an electronic drive circuit. The ratchet gear has a plurality of teeth. The electrically conducting pawl mechanism includes a pawl configured to engage one of the plurality of teeth on the ratchet gear. The an electronic drive circuit is electrically coupled to the pawl mechanism. The electronic drive circuit passes a current through the pawl mechanism such that the pawl advances the ratchet gear by one tooth pitch.

### FIELD OF THE INVENTION

This invention generally relates to appliance timers and, in particular, to a defrost timer for a refrigerator or a freezer.

### BACKGROUND OF THE INVENTION

Modern appliances such as refrigerators and freezers typically include no-frost or frost free systems or mechanisms that permit the appliance to automatically and regularly defrost itself Many conventional no-frost freezers/refrigerators include four basic components, namely a defrost timer, a heater, a defrost thermostat and a fridge/freezer thermostat commonly called a “cold control”.

Every few hours, the defrost timer activates the heater to defrost the evaporator coil in the appliance and at the same time cuts power to the compressor motor. Because the heater is disposed proximate the evaporator coil of the freezer, the heater is able to melt away any ice that has accumulated there. If the defrost thermostat sensor senses that the temperature has risen above thirty-two degrees Fahrenheit (32° F.), which is approximately equivalent to zero degrees Celsius (0° C.), the heater is turned off to limit the temperature rise, during this time any ice build up is melted. After a limited defrosting time the defrost timer disconnects the defrost heater and connects the compressor motor through the cold control again. After another few hours, the defrost timer once again activates the heater and the process is repeated. As a result, the freezer remains relatively frost free during use.

There are many different cycle time combinations for defrost and non defrost (Heating/cooling) specified by fridge/freezer manufacturers to suit their particular appliance requirements.

Unfortunately, conventional mechanical defrost timers are relatively expensive and include numerous components. Also as there are many cycle time model variations required the prior art needs many different combinations of gearing components to provided the required variations. There exists, therefore, a need in the art for a simple, low-cost defrost timer for an appliance such as a refrigerator or freezer. The invention provides such a defrost timer. These and other advantages of the invention, as well as additional inventive features, will be apparent from the description of the invention provided herein.

### BRIEF SUMMARY OF THE INVENTION

In one embodiment, a timer including a rotatable electrically non-conducting ratchet gear, an electrically conducting pawl mechanism, and an electronic drive circuit is provided. The ratchet gear has a plurality of teeth and the pawl mechanism includes a pawl. The pawl is configured to engage one of the plurality of teeth on the ratchet gear. The electronic drive circuit is electrically coupled to the pawl mechanism. The electronic drive circuit passes a current through the pawl mechanism such that the pawl advances the ratchet gear by one tooth pitch.

In another embodiment, an appliance timer including a base, a rotatable non-metal ratchet gear, a metal pawl mechanism, and an electronic drive circuit is provided. The rotatable non-metal ratchet gear is operably coupled to the base and has a plurality of teeth. The metal pawl mechanism includes a spring, a pawl, and a nickel titanium alloy wire operably coupled together and secured between first and second pins protruding from the base. The pawl is configured to engage one of the plurality of teeth on the ratchet gear. The electronic drive circuit is electrically coupled to the first and second pins and passes a current through the pawl mechanism at regular intervals. An embodiment of the electronic control circuit can vary the regular intervals at which current is passed through the pawl mechanism during a portion of the operating cycle of the timer. The current causes the wire to contract such that the pawl advances the ratchet gear by one tooth pitch.

In yet another embodiment, a method of initiating a defrost cycle in an appliance is provided. The method includes the steps of alternatively contracting and expanding an alloy wire to advance a ratchet gear and initiating the defrost cycle in the appliance when the ratchet gear has been advanced one revolution.

A benefit of embodiments of the present invention is that the timer can replace the prior defrost timers with a lower cost device. As will become more apparent from the following detailed description, another benefit is that of flexibility of setting the compressor and heater on and off times without having to use different gears. Such flexibility is also possible with fully electronic timers incorporating a relay or triac to switch the compressor/heater on and off, albeit at a substantially higher cost. As such, embodiments of the present invention provide a useful alternative to mechanical and electronic defrost timers at a lower cost than both yet providing advantages only heretofore available from an electronic defrost timer.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an exemplary embodiment of an appliance timer in accordance with the teachings of the present invention;

FIG. 2 is a top view of the appliance timer of FIG. 1;

FIG. 3 is a side view of the appliance timer of FIG. 1;

FIG. 4 is a bottom view of the appliance timer of FIG. 1;

FIG. 5 is a simplified schematic view of one embodiment of an electronic drive circuit for the appliance timer of FIG. 1; and

FIG. 6 is a simplified schematic view of an alternate embodiment of an electronic drive circuit for the appliance timer of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

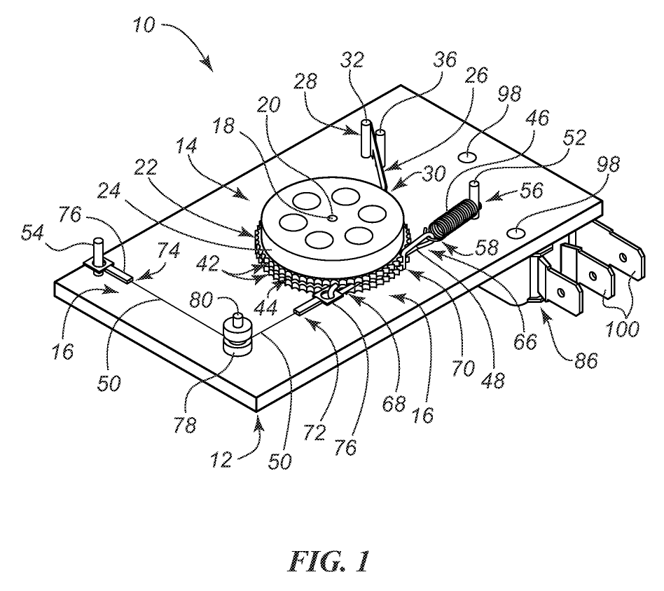

Referring to FIG. 1, an appliance timer 10 is illustrated. As will be more fully explained below, the appliance timer 10 provides a simple, low-cost timer for an appliance. In the illustrated embodiment, the appliance timer 10 is configured as a defrost timer for an appliance such as, for example, a refrigerator or freezer. Even so, the appliance timer 10 is also suitable for use on and in other appliances that have a need for timing particular operations or cycles. As shown in FIG. 1, the appliance timer 10 includes, among other things, a base 12, a ratchet gear 14, and a pawl mechanism 16.

The base 12, while depicted as a rectangular plate, may take a variety of forms depending on, for example, the space provided within the appliance (not shown) for the appliance timer 10. The base 12 is generally made from an electrically non-conducting (i.e., insulating) material such as, for example, a plastic. Even so, the base 12 may be made from a variety of other suitable materials.

In the illustrated embodiment, the ratchet gear 14 is a relatively flat, generally cylindrical gear. The ratchet gear 14 is generally formed from an electrically non-conducting material. In the illustrated embodiment, the ratchet gear 14 is formed from a plastic. Even so, other electrically non-conducting materials may be suitably employed to form the ratchet gear 14.

The base 12 supports the ratchet gear 14 in a manner that permits the ratchet gear to, at times, rotate relative to the base. In that regard, in the illustrated embodiment a ratchet gear drive shaft 18 passes through both a central channel 20 in the ratchet gear 14 and an aperture (not shown) in the base 12. The drive shaft 18 is secured to the ratchet gear 14 but not the base 12. Therefore, the drive shaft 18 and the ratchet gear 14 rotate together and the drive shaft rotates relative to the base 12.

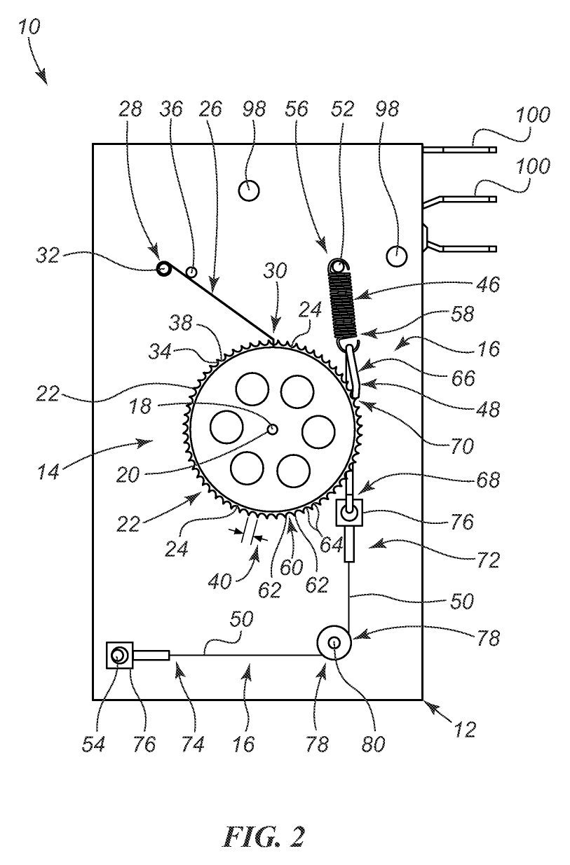

As shown in FIG. 1, the ratchet gear 14 includes a plurality of teeth 22 progressing circumferentially around a side wall 24 of the ratchet gear 14. While the teeth 22 generally extend radially outwardly from the side wall 24, the teeth are also set off at somewhat of an angle. Therefore, when viewed from above in FIG. 2, the teeth 22 generally resemble right triangles and, more particularly, cresting waves. This shape ensures that when the ratchet gear 14 is used with the pawl mechanism 16, rotation of the ratchet gear 14 is inhibited in one direction and more freely permitted in another.

In addition to the shape of the teeth 22, a blade spring 26 is also provided to prevent rotation in an undesirable direction. The blade spring 26 is a flat, resilient member having a blade spring holder 28 and an engagement end 30 on opposing ends. The blade spring holder 28 is operably coupled to a blade spring pin 32 secured to the base 12. The engagement end 30 is configured to engage with the side wall 24 and a rear surface 34 (FIG. 2) the teeth 22 on the ratchet gear 14.

A tensioning pin 36 operably coupled to the base 12 and engaged with the blade spring proximate the blade spring holder 28 biases the blade spring 32 toward the ratchet gear 14. Therefore, the engagement end 30 is generally forced to slide over the contour of the front surface 38 of the teeth 22 as the ratchet gear 14 moves. When the engagement end 30 is forcibly biased against the side wall 24 and the rear surface 34, the ratchet gear 14 is prevented from rotating in an unwanted direction. In the illustrated embodiment of FIG. 2, the ratchet gear 14 is configured to turn or rotate in a clockwise direction.

The distance between two adjacent teeth 22 on the ratchet gear 14, when measured from one tip to another, is known as a tooth pitch 40. The tooth pitch 40 of the ratchet gear 14 is generally dependant on the number of teeth 22 included on the ratchet gear 14. With more teeth 22, the tooth pitch 40 typically becomes smaller. In contrast, with less teeth 22 the tooth pitch 40 typically becomes larger.

Referring back to FIG. 1, in the illustrated embodiment the teeth 22 have been arranged on the ratchet gear 14 such that they form a pair of vertically spaced-apart rings 42 stacked one on top of the other. Because the rings 42 are vertically spaced-apart from each other, a horizontal channel 44 is developed in between the two rings 42. As shown, the horizontal channel 44 extends entirely around the outside of the ratchet gear 14.

Referring back to FIG. 2, the pawl mechanism 16 includes a spring 46, a pawl 48, and an alloy wire 50 operably coupled together. Each of these components is formed from an electrically conducting material. Therefore, the pawl mechanism 16 is electrically conducting and able to carry a current. As shown, the pawl mechanism 16 generally extends between first and second pins 52, 54. Each of the pins 52, 54 is formed from an electrically conducting material and supported by the base 12. In lieu of pins 52, 54, other supporting and electrically conducting structures are also suitably employed to support the pawl mechanism 16.

In the illustrated embodiment, the spring 46 is a coil spring (a.k.a., a helical spring) that operates to keep the pawl mechanism in tension. The spring 46 has first and second spring ends 56, 58. As shown in FIGS. 1 and 2, the first spring end 56 is operably coupled to the first pin 52. The spring 46 is generally formed from an electrically conducting material such as, for example, a hardened steel, an annealed steel, or other metallic or electrically conducting medium. In one embodiment, the spring 46 is formed from beryllium copper because of its low electrical resistance.

In the illustrated embodiment, the pawl 48 is formed from a folded or shaped length of round wire. To correspond to that round shape, a slot 60 formed in between the tips 62 of each set of adjacent teeth 22 on the ratchet gear 14 has a generally rounded bottom 64. Therefore, the pawl 48 will easily fit or seat within the slot 60 formed between the teeth 22 on the ratchet gear 14. In addition, the pawl 48 will also easily fit and move within the channel 44 (see FIG. 1) formed in between the rings 42 of teeth 22 on the ratchet gear.

The combination of the shape of the slot 60, the shape of the pawl 48, and the tension of the spring 46 encourages the pawl to remain in contact with the ratchet gear 14 when the pawl is driving the ratchet gear, as will be more fully explained below. The combination also permits the pawl 48 to move back over the teeth 22 when the pawl is pulled in a direction back toward the first pin 52 by the spring 46.

The pawl 48 is formed from an electrically conducting material such as, for example, a hardened steel, an annealed steel, and the like. Even so, other electrically conducting materials may be suitably employed in forming the pawl 48. As shown, the pawl 48 includes first and second pawl ends 66, 68. The first pawl end 68 is operably coupled to the second spring end 58. In the illustrated embodiment, the first pawl end 66 is formed into a loop to facilitate the coupling of the pawl and the spring 46. Even so, other coupling structures, members, or mechanisms may be used to operably couple the first pawl end 66 to the second spring end 58.

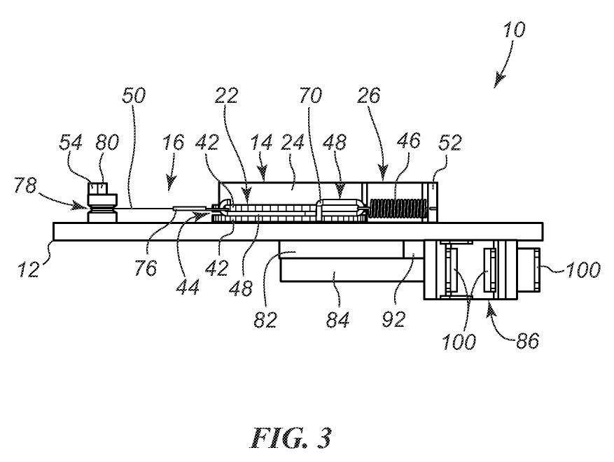

As shown in FIGS. 1 and 3, the pawl 48 includes an engagement member that, in the illustrated embodiment, is formed by a downwardly bent portion 70 of the pawl 48. The downwardly bent portion 48 is generally interposed between first and second pawl ends 66, 68. The downwardly bent portion 70 is configured to seat within the slot 60 formed between adjacent teeth 22 on each of the rings 44. Due to the tension created in the pawl mechanism 16 by the spring 46, the pawl 48 is generally forcibly biased against the rear surface 34 of one of the teeth 22 when the pawl is within one of the slots 30 formed between adjacent teeth 22.

The second pawl end 68 is operably coupled to a first alloy wire end 72. In the illustrated embodiment, the second pawl end 68 is formed into a rounded hook to facilitate the coupling of the pawl 48 and the alloy wire 50. Even so, other coupling structures, members, or mechanisms may be used to operably couple the second pawl end 68 to the first alloy wire end 72.

As shown in FIG. 2, the alloy wire 50 includes a second alloy wire end 74 in addition to the first alloy wire end 72 noted above. In the illustrated embodiment, the alloy wire 50 is operably coupled to crimp tabs 76 at the first and second alloy wire ends 72, 74. As shown, these crimp tabs 76 are used to attach the alloy wire 50 to the pawl 48 and the second pin 54. Therefore, the alloy wire 50 generally extends between the second pawl end 68 and the second pin 54. Despite crimp tabs 76 being illustrated, other coupling structures, members, or mechanisms may be employed on the first and second alloy wire ends 72, 74 to attach the alloy wire 50 to both the pawl 48 and the second pin 54.

The alloy wire 50 is an electrically conducting wire that is, in general, formed from more than one metal (e.g., a bi-metal). In one embodiment, the alloy wire 50 is a nitinol wire. Nitinol, which is an acronym for Nickel Titanium Naval Ordnance Laboratory, is a family of intermetallic materials, which contain a nearly equal mixture of nickel (55 wt. %) and titanium. Even so, other elements can be added to adjust or “tune” the material properties of the nitinol.

In the illustrated embodiment, the alloy wire 50 is a nitinol wire manufactured by Dynalloy, Inc., of Costa Mesa, Calif., and sold under the trademark Flexinol® (hereinafter “Flexinol”). A Flexinol wire typically contracts between about 2% to about 5% of its length when an electrical current is passed through the wire or the wire is otherwise heated. After contracting, the Flexinol wire will return to its original length (or close thereto) under a sufficient biasing force (e.g., the spring 46) when cooled. Because of this characteristic, the Flexinol wire is referred to as a “shape memory” wire (SMW). Without a sufficient biasing force, the Flexinol wire will not return to its original length. The biasing force is needed to reset, or stretch, the Flexinol wire back to its original length during the low temperature phase.

Under certain conditions, the Flexinol wire will contract up to about 8% to about 10% of its length. However, for longer lifetime (greater than one million cycles and even up to tens of millions of cycles), contraction of the Flexinol wire should be restricted to between about 5% to about 6% of its length. While the length of the Flexinol wire will change during contraction and expansion, the absolute volume of the wire remains constant.

The Flexinol wire is generally available in a variety of sizes each having a variety of different characteristics. For example, for a Flexinol wire having a diameter of about 0.001 of an inch, the wire has a resistance of about 45 Ohms per inch, has about 7 grams of pull force, requires a current of about 20 milliamps (mA) for suitable contraction, contracts in about 1 second, and takes about 0.1 of a second to cool to 70° C. However, for a Flexinol wire having a diameter of about 0.02 of an inch, the wire has a resistance of about 0.16 Ohms per inch, has about 3,562 grams of pull force, requires a current of about 4,000 milliamps (mA) for suitable contraction, contracts in about 1 second, and takes about 17 seconds to cool to 70° C. Flexinol wires with diameters between 0.001 of an inch and 0.02 of an inch will have characteristics and properties within the parameters noted above.

In the illustrated embodiment of FIG. 2, to reduce the overall size and dimension of the appliance timer 10 the alloy wire 50 is routed around a pulley 78. The pulley 78 is operably coupled to the base 12 via a pulley pin 80. The pulley 78 freely rotates around the pulley pin 80 as the alloy wire 50 contracts and then expands back to its original length. While other angles are possible, the pulley 78 is located on the base 12 such that the alloy wire 50 forms an approximately 90° angle when the wire is viewed from above as in FIG. 2.

Referring now to FIG. 3, one embodiment of the appliance timer 10 also includes a gear box 82, a cam 84, and a micro switch 86. The gear box 82 is interposed between the base 12 and the cam 84. The gear box 82 is configured to transmit the motion of drive shaft 18, which is generated by the ratchet gear 14, to the cam 84. Thus, the cam 84 rotates as a result of the rotation of the ratchet gear 14.

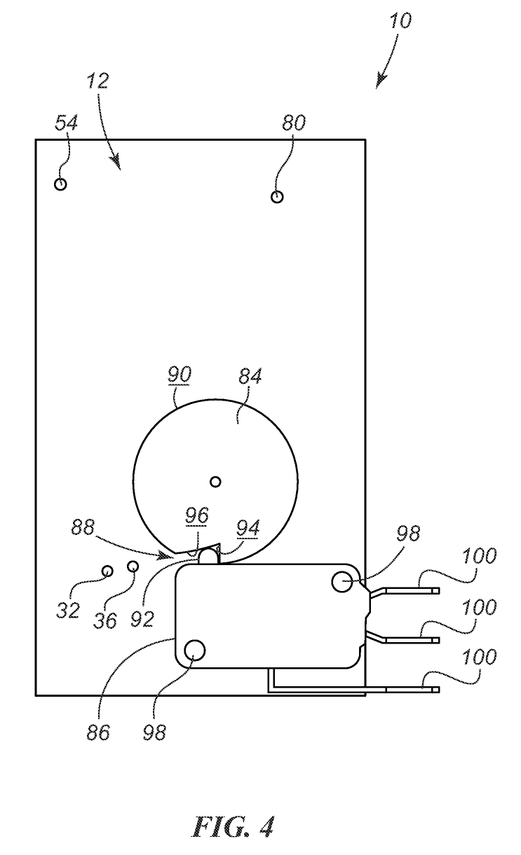

As shown in FIGS. 3 and 4, the cam 84 is generally cylindrical save for a generally triangular-shaped notch 88 interrupting the outer surface 90 of the cam. The notch 88 is sized and dimensioned to receive a cam follower 92 found on the micro switch 86. In particular, the notch 88 extends radially inwardly into the cam 84 such that the cam includes a flat surface 94 and a contoured surface 96. In the orientation illustrated in FIG. 4, the cam 84 is configured to rotate in a counterclockwise direction.

The micro switch 86 is located adjacent to the cam 84 such that the micro switch 86 and the cam 84 are operatively engaged. The micro switch 86 is supported by the base 12 through a pair of micro switch pins 98. Although two micro switch pins 98 are shown, more or few may be employed so that the base 12 will support the micro switch 86. Also, components or mechanisms other than the pins 98 are used in other embodiments to secure the micro switch 86 to the base 12. As shown, the micro switch 86 includes a plurality of terminals 100 and the cam follower 92. The terminals 100 are configured to electronically couple with, for example, a wiring harness, an electrical connector, wires or leads, and the like.

The cam follower 92 is spring-loaded or otherwise configured to project outwardly and away from the remainder of the micro switch 86. In the illustrated embodiment, the cam follower 92 has a partially rounded outer surface 102. Therefore, the cam follower 92 is suitable for sliding along the outer surface 90, the contoured surface 96, and the flat surface 94 of the cam 84.

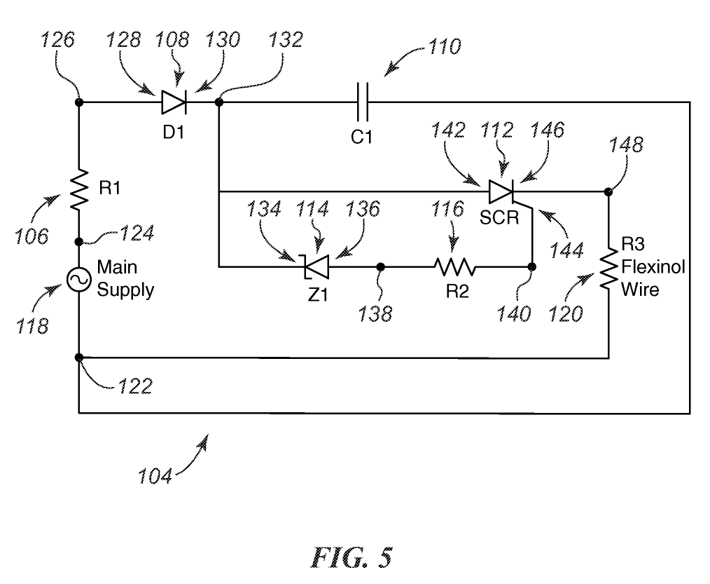

Referring now to FIG. 5, a simplified schematic of one embodiment of an electronic drive circuit 104 for the appliance timer 10 is depicted. The electronic drive circuit 104 is, in general, in electrical communication with the pawl mechanism 16 and, in particular, the alloy wire 50. The electronic drive circuit 104 includes a first resistor 106, a diode 108, a capacitor 110, a silicon controlled rectifier (SCR) 112, a Zener diode 114, and a second resistor 116. As will be more fully explained below, these components cooperate to release an electrical charge at regular or known intervals to the alloy wire 50 (shown schematically in FIG. 5 as a resistance, namely third resistor 120).

Despite FIG. 5 including a symbol for an alternating current (AC) power supply 118, the power supply is not normally considered an electrical component included in the electronic drive circuit 104. Instead, the symbol for the AC power supply 118 reflects the fact that the electronic drive circuit 104 is configured to receive a sinusoidal AC signal from, for example, a wall outlet or a power supply of an appliance.

As mentioned above, the third resistor 120 depicted in the electronic drive circuit 104 schematic is not a discrete resistor found in the electronic drive circuit 102. Instead, the third resistor 120 schematically represents the overall resistance of the alloy wire 50 from FIG. 1. In an alternate embodiment, the third resistor 120 represents the overall resistance of the entire pawl mechanism 16.

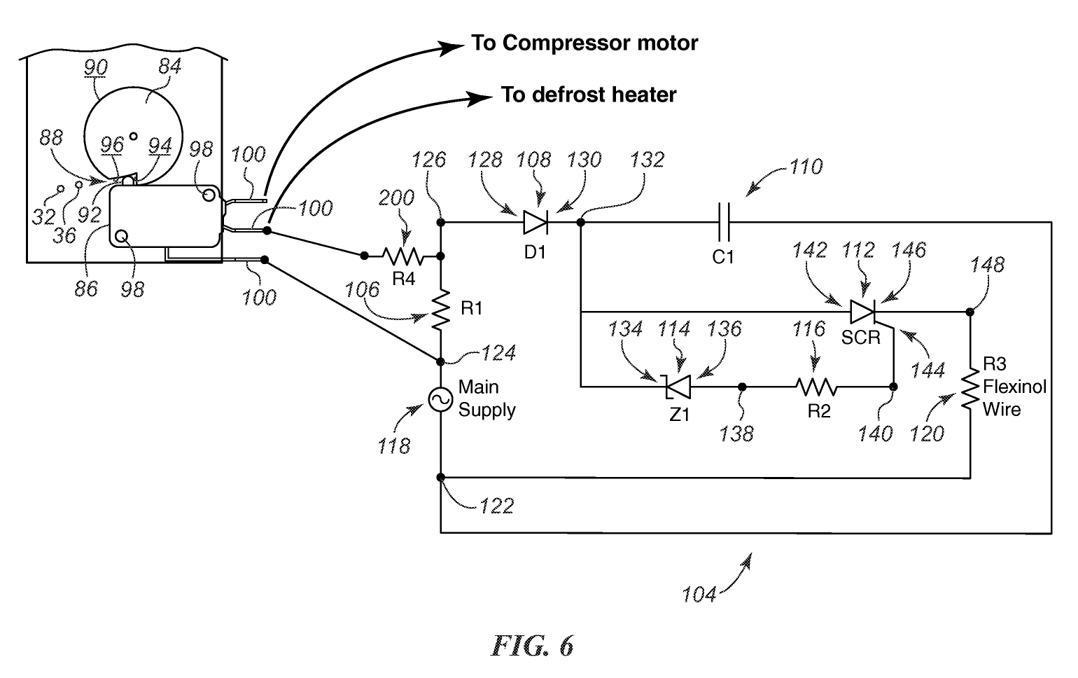

Still referring to FIG. 5, the AC power supply 118 (e.g., 110 VAC at approximately 50 to 60 Hz) is electrically coupled to the electronic drive circuit 104 between a first node 122 and a second node 124. The first resistor 106 is disposed between the second node 124 and a third node 126. In one embodiment, the first resistor 106 is a variable resistor having a variable resistance that can easily be adjusted. By adjusting the resistance of the first resistor 106, the time interval between the charging and discharge of the capacitor 110 may be regulated and, therefore, set as desired. This allows the manufacturers to easily adjust the cycle time rather than using different combinations of gears. Indeed, in an alternate embodiment illustrated in FIG. 6, the addition of variable resistor 200 enables both the on and off defrost times to be adjusted.

Returning again to FIG. 5, an anode 128 of the diode 108 is coupled to the third node 126 while a cathode 130 of the diode is coupled to a fourth node 132. The capacitor 110 is disposed between the fourth node 132 and the first node 122. Because the diode 108 rectifies the AC signal delivered to the electronic drive circuit 104 by the AC power supply 118, a half-wave or rectified signal is present at the fourth node 132 and experienced by electrical components connected thereto, such as the capacitor 110. The rectified signal at the fourth node 132 charges the capacitor 110 to a predetermined or known voltage depending on the characteristics of the capacitor. The capacitor 110 is able to, at least temporarily, store this charge.

A cathode 134 of the Zener diode 114 is coupled to the fourth node 132 while an anode 136 is coupled to a fifth node 138. The second resistor 116 is disposed between the fifth node 138 and a sixth node 140. An anode 142 of the SCR 112 is coupled to the fourth node 132, a gate 144 of the SCR is coupled to the sixth node 140, and a cathode 146 of the SCR is coupled to a seventh node 148. Each of the seventh node 148 and the first node 122 is coupled to one of the first and second pins 52, 54 on the base 12 (see FIG. 1). Therefore, the pawl mechanism 16 of FIG. 1 is electrically coupled to the electronic drive circuit 104. The third resistor 120, which represents the alloy wire 50 in the illustrated embodiment, is shown in the schematic as being disposed between the seventh node 148 and the first node 122.

In operation, the capacitor 110 shown in FIG. 5 is charged by the rectified signal at the fourth node 132. When the energy stored in the capacitor 110 reaches or exceeds the reverse breakdown voltage of the Zener diode 114, the Zener diode conducts and a current sufficient to trigger the SCR 112 is experienced at the gate 144 of the SCR. The triggered SCR 112 conducts and permits the capacitor 110 to discharge its stored energy past the SCR 112 to the seventh node 148. Because the seventh node 148 and the first node 122 are coupled to the first and second pins 52, 54, an electric current is passed through the pawl mechanism 16 and, in particular, the alloy wire 50 shown in FIG. 1.

The current passing through the alloy wire 50, and the heat generated by the current, causes the alloy wire to contract in length. The contracted alloy wire 50 forces the pawl 48 to exert a biasing force on the rear surface 34 of one of the teeth 22 on the ratchet gear 14. The biasing force causes the ratchet gear 14 to rotate and advance by one tooth pitch 40 in the clockwise direction as oriented in FIG. 1. The biasing force also causes the blade spring 26 to slide over the front surface 38 of one of the teeth 22 and engage the rear surface 34 of another tooth in the slot 60 immediately behind the slot the blade spring was just seated in. Therefore, the blade spring 26 locks the ratchet gear 14 in place and prevents undesirable rotation of the ratchet gear in the counterclockwise direction.

When the ratchet gear 14 is advanced by one tooth pitch 40, the drive shaft 18 translates the rotation of the ratchet gear to the gear box 82. In turn, the gear box 82 translates the rotation to the cam 84. In the orientation of FIG. 4, the cam 84 rotates in a counterclockwise direction by, for example, one tooth pitch 40 (or some other predetermined distance) due to the fact that the ratchet gear 14 was advanced one tooth pitch. As the cam 84 rotates, the outer surface 102 of the cam follower 92 on the micro switch 86 slides upon the outer surface 90 of the cam 84. The cam 84 then remains in that position until the drive shaft 18 is further rotated.

After the cam 84 has been locked in position as noted above, eventually the current experienced at the gate 144 of the SCR 112 is no longer sufficient to trigger the SCR and the SCR closes. The closed SCR 112 results in the capacitor 110 once again starting to build a charge and the current to cease passing through the alloy wire 50. The lack of current through the alloy wire 50 permits the alloy wire to cool. The lack of current also permits the spring 46 to expand the alloy wire 50 back toward or to its original length. When this occurs, the pawl 48 is biased back toward the first pin 52 and slides over the front surface 38 of one of the teeth 22.

When the alloy wire 50 has expanded to a sufficient length, the pawl 48 falls into the slot 60 immediately behind the slot in which the pawl mechanism was just located. In other words, the pawl 48 moves about one tooth pitch 40 in a linear direction back toward the first pin 52. The pawl 48 once again engages with the rear surface 34 of another of the teeth 22 and is in position to advance the ratchet gear 14 by another tooth pitch 40.

When the capacitor 110 has been sufficiently charged, the above-described cycle is repeated and the cam 84 is rotated (in a counterclockwise direction in FIG. 4) by one tooth pitch 40 (or some other predetermined distance) due to the fact that the ratchet gear 14 was advanced one tooth pitch. The time interval between the charge and discharge of the capacitor 110 is controlled by, among other things, varying the resistance of the first resistor 106 in the electronic drive circuit 104.

Eventually, the cam 84 is rotated to a position where the cam follower 92 approaches the flat surface 94 of the notch 88. When the cam follower 92 passes the flat surface 94 due to continued rotation of the cam 84, the cam follower fully springs into the notch 88 and the micro switch 86 is activated or deactivated depending on the micro switch 86 configuration. In the illustrated embodiment, because there is a single notch 88 on the cam 84, the micro switch 86 will be activated once per revolution of the cam. Even so, additional notches (not shown) may be included on the cam 84 such that the micro switch 86 is activated more than once per revolution.

The activated micro switch 86 causes, for example, the defrost mechanism or system (not shown) in the appliance to turn on. That defrost mechanism then defrosts the appliance. In other embodiments, the activated micro switch 86 will temporarily activate or deactivate some other feature or function of the appliance.

As the cam 84 continues to rotate, the cam follower 92 encounters the contoured surface 96 of the notch 88. The contoured surface 96 begins progressively forcing the cam follower 92 back into the remainder of the micro switch 86. When the cam follower 92 has been rotated such that the cam follower leaves the contoured surface 96 of the notch 88 and begins sliding upon the round and regular outer surface 90 of the cam 84, the micro switch is deactivated.

The deactivated micro switch 86 causes, for example, the defrost mechanism or system (not shown) in the appliance to turn off. That defrost mechanism then discontinues defrosting the appliance. However, the cam 84 continues to rotate by one tooth pitch 40 along with the ratchet gear 14 each time the electronic drive circuit 104 supplies a current to the alloy wire 50. Therefore, the defrost cycle in the appliance is repeated at regular, spaced apart intervals in the illustrated embodiment.

As introduced above and as illustrated in FIG. 6, an alternate embodiment of the electronic drive circuit 104 includes a resistor 200 coupled between node 126 and contact 100_{b} of micro switch 86. This contact 100_{b} is also coupled to the defrost heater. Contact 100ₐ of micro switch 86 is coupled to node 124, and contact 100_{c} is coupled to the compressor motor. In this configuration active feedback is given to the electronic drive circuit 104 when in the defrost mode. This causes the cycle time of the indexing to speed up due to the extra charge received through resistor 200 during the defrost mode. In an embodiment wherein resistors 106 and 200 are both variable resistors, then both the on and off defrost cycle times can be adjusted. This removes the need for different gearing to make different models, with automatic setting possible on the production line.

Form the foregoing, those skilled in the art will appreciate that the appliance timer 10 described herein may be used as a simple, low-cost defrost timer for an appliance. In particular, the appliance timer 10 provide a method of slowly rotating a cam 84 to activate the micro switch 86 and initiate the defrost cycle in the appliance.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A timer comprising:
a rotatable ratchet gear having a plurality of teeth;
an electrically conducting pawl mechanism including a pawl, the pawl configured to engage one of the plurality of teeth on the ratchet gear; and
an electronic drive circuit electrically coupled to the pawl mechanism, the electronic drive circuit passing a current through the pawl mechanism such that the pawl advances the ratchet gear by one tooth pitch.

2. The timer of claim 1, wherein the pawl mechanism includes an alloy wire, the alloy wire contracting in length when the electronic drive circuit passes the current through the pawl mechanism.

3. The timer of claim 2, wherein the pawl mechanism includes a tension spring operably coupled to the pawl, the tension spring biasing the alloy wire back to a relaxed length when the electric drive circuit is not passing the current through the alloy wire.

4. The timer of claim 1, wherein the pawl mechanism includes an alloy wire extending between first and second pins and biased by a tension spring, the first and second pins electrically coupled to the electronic drive circuit.

5. The timer of claim 1, further comprising a pulley and wherein the pawl mechanism includes a nitinol wire, the nitinol wire bent around the pulley.

6. The timer of claim 1, further comprising a cam and a micro switch, the cam actuating the micro switch at least once per revolution of the ratchet gear.

7. The timer of claim 6, wherein timer further comprises a gear box, the gear box interposed between and operably coupled to the cam and the ratchet gear.

8. The timer of claim 1, wherein the electronic drive circuit includes a silicon controlled rectifier (SCR).

9. The timer of claim 1, wherein the electric drive circuit passes the current through the pawl mechanism at predetermined intervals.

10. The timer of claim 1, wherein the electronic drive circuit includes a silicon controlled rectifier (SCR), a capacitor, and a Zener diode in electrical communication with each other, the SCR conducting when the Zener diode reaches a Zener breakdown voltage, the conducting SCR permitting the capacitor to release an electric charge such that the current passes through the pawl mechanism.

11. The timer of claim 10, further comprising a cam and a micro switch, the cam actuating the micro switch at least once per revolution of the ratchet gear, and wherein the electronic drive circuit is configured to increase at rate at which the electronic drive circuit passes the current through the pawl mechanism when the cam actuates the micro switch.

12. The timer of claim 10, wherein the pawl mechanism includes an alloy wire, the alloy wire electrically coupled to a cathode of the silicon controlled rectifier (SCR).

13. The timer of claim 12, wherein the electronic drive circuit includes a capacitor, the capacitor in parallel with a combination of the Zener diode, the silicon controlled rectifier (SCR), and the alloy wire.

14. The timer of claim 13, wherein the electronic drive circuit further includes a first resistor in series with a diode, a resistance of the first resistor determining a time interval between charging and discharging of the capacitor, the diode rectifying an alternating current signal used to charge the capacitor.

15. The timer of claim 14, wherein the electronic drive circuit further includes a second resistor in series with the diode and in parallel with the first resistor, a combined resistance of the first resistor and second resistor determining a time interval between charging and discharging of the capacitor during at least a portion of operation of the electronic drive circuit.

16. An appliance timer comprising:
a base;
a rotatable ratchet gear operably coupled to the base, the ratchet gear having a plurality of teeth;
a metal pawl mechanism including a spring, a pawl, and a nickel titanium alloy wire operably coupled together and secured between first and second pins protruding from the base, the pawl configured to engage one of the plurality of teeth on the ratchet gear; and
an electronic drive circuit electrically coupled to the first and second pins, the electronic drive circuit passing a current through the pawl mechanism at regular intervals, the current causing the wire to contract such that the pawl advances the ratchet gear by one tooth pitch.

17. The appliance timer of claim 16, wherein the spring expands the wire after the current is removed from the pawl mechanism such that the pawl engages with a next one of the plurality of teeth on the ratchet gear.

18. The appliance timer of claim 16, wherein the spring returns the wire back to about an original length after the current is removed from the pawl mechanism such that the pawl engages with a next one of the plurality of teeth on the ratchet gear and the appliance timer further comprises a cam and a micro switch, the cam actuating the micro switch once per revolution of the ratchet gear.

19. A method of initiating a defrost cycle in an appliance comprising the steps of:
alternatively contracting and expanding an alloy wire to advance a ratchet gear;
initiating the defrost cycle when the ratchet gear has been advanced a predetermined amount.

20. The method of claim 19, wherein the contracting is performed by passing a current through the alloy wire at spaced apart intervals and the predetermined amount is one revolution.
